(19) United States
(12) Patent Application Publication
(10) Pub. No.: US 2021/0059444 A1
(43) Pub. Date: Mar. 4, 2021

(54) EATING UTENSIL ASSEMBLY INCLUDING THROUGH-OPENING EXTENDING UTENSIL AND RELATED METHODS

(71) Applicant: SNAP OUT SOLUTIONS, LLC, Lake Mary, FL (US)

(72) Inventor: Kimberly A. TRUOG, Lake Mary, FL (US)

(21) Appl. No.: 17/006,233

(22) Filed: Aug. 28, 2020

Related U.S. Application Data
(60) Provisional application No. 62/893,027, filed on Aug. 28, 2019.

(51) Int. Cl. A47G 21/06; A47G 21/02

(52) U.S. Cl. CPC A47G 21/06; B26B 3/02; A47G 21/103; A47G 21/023

(57) ABSTRACT

An eating utensil assembly may include a first eating utensil that may include a first handle having first and second opposing ends and that includes spaced apart sidewalls defining a through-opening therebetween, and an end support member coupled between the spaced apart sidewalls adjacent the first end to define a recessed area relative to the spaced apart sidewalls. The first eating utensil may also include a first eating utensil head coupled adjacent the second end of the first handle. The eating utensil assembly may further include a second eating utensil removably carried by the end support member within the through-opening and that may have a length greater than a length of the through-opening so that the second eating utensil extends through the recessed area and across the end support member. Breakaway tabs may removably couple the second eating utensil to the spaced apart sidewalls within the through-opening.

### RELATED APPLICATIONS

The present application claims the priority benefit of provisional application Ser. No. 62/893,027 filed on Aug. 28, 2019, the entire contents of which are herein incorporated by reference.

### TECHNICAL FIELD

The present application is directed to utensils, and more particularly, to eating utensils and related methods.

### BACKGROUND

An eating utensil is a common tool for cutting and eating food. For example, an eating utensil, which may be considered a form of cutlery, may include a fork, knife, or spoon. A fork, for example, typically includes a handle and tines extending outwardly from the handle. A spoon typically includes a handle and a relatively small oval or round bowl coupled to an end of the handle. A knife also typically includes a handle and a cutting blade at an end of the handle.

Traditionally, the knife, fork, and spoon are separate utensils. In other words, for each eating function, there is typically a corresponding utensil. Over time, the shape and size of an eating utensil has changed, for example, based upon a type of use (e.g., single or multi-use), type of food, etc.

One such change to the shape or size of a typical eating utensil has been to combine eating utensils so that a single eating utensil has both the shape and function of what has been traditionally a single eating utensil. For example, a spork is a combination spoon and fork, a sporf is a combination spoon, fork, and knife, a splayd is a combination spoon, fork, and knife, and a spife is a combination spoon and knife.

### SUMMARY

An eating utensil assembly may include a first eating utensil. The first eating utensil may include a first handle having first and second opposing ends and that includes spaced apart sidewalls defining a through-opening therebetween, and an end support member coupled between the spaced apart sidewalls adjacent the first end to define a recessed area relative to the spaced apart sidewalls. The first eating utensil may also include a first eating utensil head coupled adjacent the second end of the first handle. The eating utensil assembly may also include a second eating utensil removably carried by the end support member within the through-opening. The second eating utensil may have a length greater than a length of the through-opening so that the second eating utensil extends through the recessed area and across the end support member. The eating utensil assembly may further include a plurality of breakaway tabs removably coupling the second eating utensil to the spaced apart sidewalls within the through-opening.

The spaced apart sidewalls may have a thickness. The recessed area may be sized to be the thickness of the sidewalls, for example.

The second eating utensil may include a second handle, and a second eating utensil head coupled to the second handle and that includes a plurality of serrations. The first eating utensil head may include a plurality of spaced apart tines, for example. The second eating utensil may include a pair of chopsticks, for example.

The end support member may be coupled between the spaced apart sidewalls at the first end. The through-opening may have a through-opening contour, and the second eating utensil handle may have a second handle contour matching the through-opening contour, for example.

The second eating utensil may further include a halo carried by an edge of the second eating utensil head and aligned with one of the spaced apart sidewalls. The eating utensil assembly may also include at least one further breakaway tab between the halo and the one of the spaced apart sidewalls, for example.

A method aspect is directed to a method of making an eating utensil assembly that may include forming a first eating utensil that includes a first handle having first and second opposing ends. The first handle may include spaced apart sidewalls defining a through-opening therebetween, and an end support member coupled between the spaced apart sidewalls adjacent the first end to define a recessed area relative to the spaced apart sidewalls. The first eating utensil may also include a first eating utensil head coupled adjacent the second end of the first handle. The method may further include forming a second eating utensil removably carried by the end support member within the through-opening. The second eating utensil may have a length greater than a length of the through-opening so that the second eating utensil extends through the recessed area and across the end support member. The method may also include forming a plurality of breakaway tabs removably coupling the second eating utensil to the spaced apart sidewalls within the through-opening.

### BRIEF DESCRIPTION OF THE DRAWINGS

FIG. 1 is an enlarged perspective view of an eating utensil assembly according to an embodiment.

FIG. 2 is a top view of the eating utensil assembly of FIG. 1.

FIG. 3 is a side view of the eating utensil assembly of FIG. 1.

FIG. 4 is a bottom view of the eating utensil assembly of FIG. 1.

FIG. 5 is an enlarged cross-sectional view of a portion of the eating utensil assembly taken along line 5-1 of the eating utensil assembly of FIG. 2.

FIG. 6 is a top view of the eating utensil assembly according to another embodiment.

FIG. 7 is a side view of the eating utensil assembly of FIG. 6.

FIG. 8 is a bottom view of the eating utensil assembly of FIG. 6.

FIG. 9 is an enlarged cross-sectional view of a portion of the first eating utensil taken along line 9-1 of the eating utensil assembly of FIG. 6.

FIG. 10 is an enlarged cross-sectional view of a portion of the second eating utensil taken along line 9-1 of the eating utensil assembly of FIG. 6.

FIG. 11 is a top view of an eating utensil assembly in accordance with another embodiment.

FIG. 12 is a top view of an eating utensil assembly in accordance with yet another embodiment.

FIG. 13 is an enlarged perspective view of an eating utensil assembly according to another embodiment.

FIG. 14 is a top view of the eating utensil assembly of FIG. 13.

FIG. 15 is a side view of the eating utensil assembly of FIG. 13.

FIG. 16 is a bottom view of the eating utensil assembly of FIG. 13.

FIG. 17 is an enlarged cross-sectional view of a portion of the eating utensil assembly taken along line 17-1 of the eating utensil assembly of FIG. 14.

FIG. 18 is an enlarged perspective view of an eating utensil assembly according to another embodiment.

FIG. 19 is a top view of the eating utensil assembly of FIG. 18.

FIG. 20 is a side view of the eating utensil assembly of FIG. 18.

FIG. 21 is a bottom view of the eating utensil assembly of FIG. 18.

FIG. 22 is a top view of an eating utensil assembly in accordance with another embodiment.

FIG. 23 is a top view of an eating utensil assembly in accordance with another embodiment.

FIG. 24 is a top view of an eating utensil assembly in accordance with another embodiment.

FIG. 25 is a top view of an eating utensil assembly in accordance with another embodiment.

FIG. 26 is a top view of an eating utensil assembly in accordance with another embodiment.

FIG. 27 is a top view of FIG. 26 illustrating separation of the eating utensil assembly.

FIG. 28 is a bottom view of the eating utensil assembly of FIG. 26.

FIG. 29 is a bottom view of FIG. 26 illustrating separation of the eating utensil assembly.

FIG. 30 is a side view of the eating utensil assembly of FIG. 26.

FIG. 31 is another side view of the eating utensil assembly of FIG. 26.

FIG. 32 is an enlarged cross-sectional view of a portion of the eating utensil assembly of the eating utensil assembly of FIG. 26.

FIG. 33 is an enlarged cross-sectional view of a portion of the eating utensil assembly in accordance with another embodiment.

FIG. 34 is a top view of an eating utensil assembly in accordance with another embodiment.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime and multiple prime notation, and numbers in increments of one-hundred are used to refer to like elements in different embodiments.

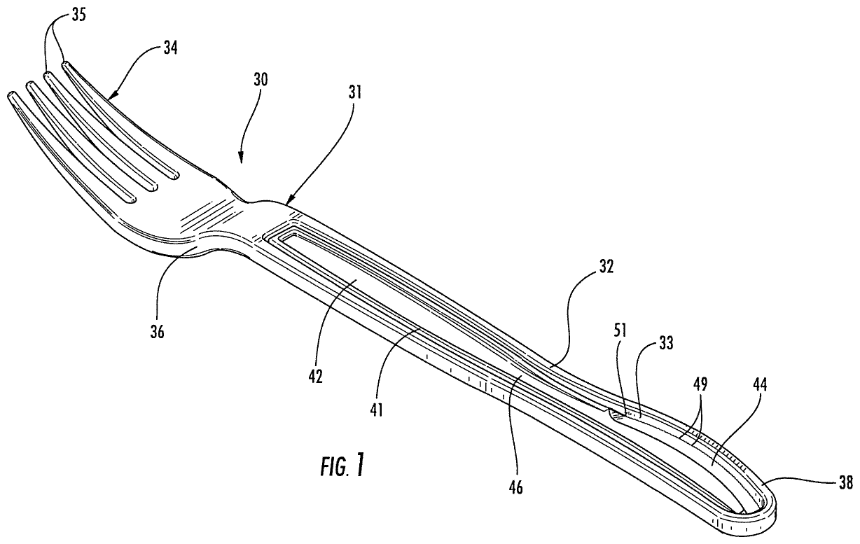

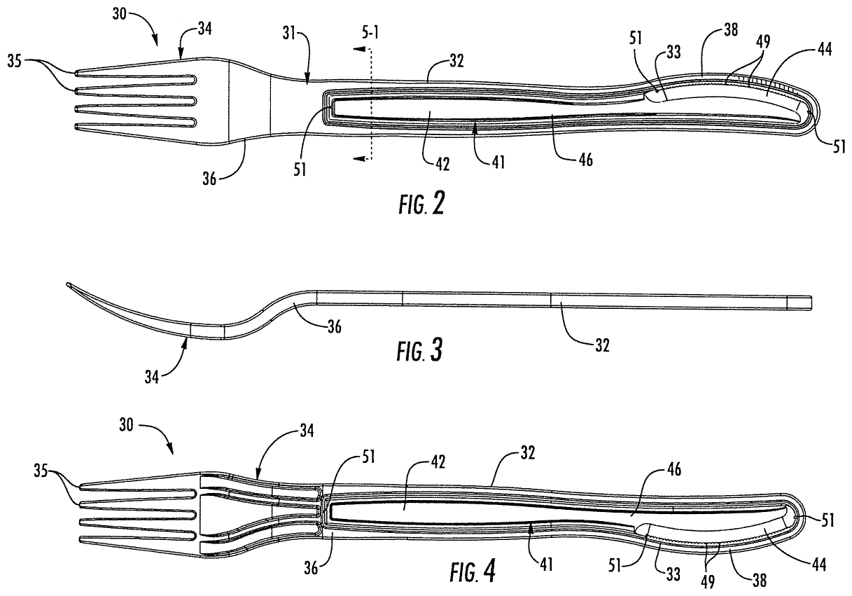

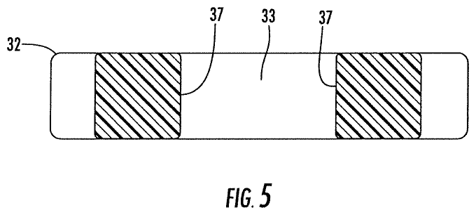

Referring initially to FIGS. 1-5, an eating utensil assembly 30 includes a first eating utensil 31 that is illustratively in the form of a fork. The first eating utensil 31 includes a first handle 32 having an opening 33 therein. The first handle 32 is illustratively planar in shape and also has an elongate shape.

A curved eating utensil head illustratively in the form of a fork head 34 is coupled to an end 36 of the first handle 32. In particular, the fork head 34 includes tines 35 that extend outwardly from the end 36 of the first handle.

The opening 33 in the first handle 32 is a through-opening. In other words, the opening 33 extends through the first handle 32. The opening 33 defines sidewalls 37. Exemplary dimensions of the first eating utensil 31 may be 8 inches long by about 1 inch wide by about 0.6 inches high, with the first handle 32 having dimensions of about 6 inches by 0.18 inches by 0.9 inches. Of course, the first eating utensil 31, including the first handle 32, may be other dimensions.

The eating utensil assembly 30 also includes a second eating utensil 41 removably carried by the first eating utensil 31, and more particularly, within the opening 33 in the first handle 32. The second eating utensil 41 is illustratively in the form of a knife and includes a second handle 42 and a cutting blade 44 that includes serrations 49 coupled to an end 46 of the second handle. The second eating utensil is carried within the opening 33 aligned lengthwise with the first handle 32. In other words, both the first and second eating utensils 31, 41 are aligned lengthwise.

Coupling bodies, for example, in the form of breakaway tabs 51 are in the opening and couple the first eating utensil 31 to the second eating utensil 41 within the opening 33. More particularly, the opening 33 and the second eating utensil 41 have a same shape (i.e., knife shape), with the opening sized slightly larger than the second eating utensil to receive the second eating utensil therein. The first handle 32 may have an enlarged width portion 38 opposite the fork head 34 to accommodate an opening and thus the second eating utensil 41. Of course, the first handle 32 may have other or additional shapes to accommodate different sized and shaped second eating utensils 41, for example, knives.

The breakaway tabs 51 are spaced apart, along the perimeter of the opening 33 and between the sidewalls 37 and the second eating utensil 41. The breakaway tabs 51 conceptually maintain the second eating utensil 41 suspended within the opening 33. The breakaway tabs 51 may be sized, for example, to space the second eating utensil 41 from the first eating utensil 31 by about 0.02 inches or less. In other words, the breakaway tabs 51 may be 0.02 inches or less in size. Of course, the breakaway tabs 51 may be other dimensions, and each of the tabs need not be the same size.

The second eating utensil 41 is removably carried within the opening 33 flush with an upper surface of the first handle 32. The second eating utensil 41 may also be removably carried within the opening 33 flush with a lower surface of the first handle 32. In other words, the second eating utensil 41, when carried within the opening 33, may not protrude from the opening. This may allow more comfortable use and/or gripping when using only the fork or first eating utensil 31 without removing the second eating utensil 41, and which may give the appearance of a single or monolithic eating utensil.

The breakaway tabs 51, and the first and second eating utensils 31, 41 may be formed of plastic, for example, similar to that of disposable cutlery or utensils, as will be appreciated by those skilled in the art. However, the breakaway tabs 51, and the first and second eating utensils 31, 41 may be another material, for example, and may include metal.

In operation, a user desirous of using the second eating utensil 41, or knife, may “snap” the second eating utensil out from within the opening 33. A downward or upward force on the second eating utensil 41 relative to the first handle 32 causes the second eating utensil to separate from the breakaway tabs 51. The breakaway tabs 51 may additionally or alternatively separate from the sidewalls 37 in the opening 33 allowing the second eating utensil 41 to be used independently of the first eating utensil 31.

As will be appreciated by those skilled in the art, in addition to increased convenience, for example, the eating utensil assembly 30 described herein may be particularly advantageous for reducing disposable eating utensil waste. In particular, the amount of material for the eating utensil assembly 30 yields two eating utensils. Additionally, since two or even three utensils are formed in a single utensil body, for example, a user would use a single eating utensil assembly reducing packaging and space, for example, for shipping and counter space at a restaurant. In other words, instead of using a separate utensil or a separate fork, knife, and/or spoon, a single eating utensil assembly 30 described herein may be used, reducing waste by as much as three-times, which also corresponds to reduced cost.

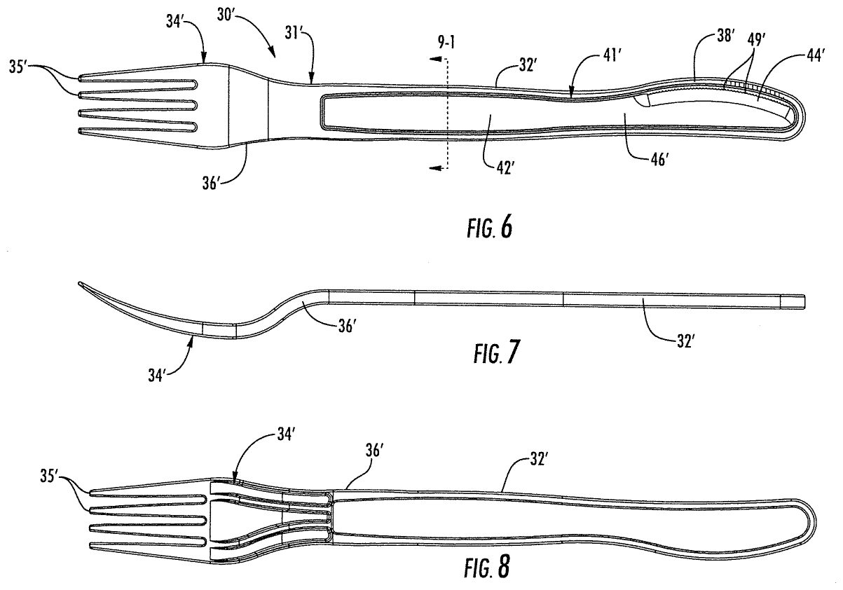

Referring now to FIGS. 6-10, in another embodiment, the opening 33′ in the first handle 32′ is a blind opening. In other words, the opening 33′ does not extend all the way through the first handle 32′. The opening 33′ defines sidewalls 37′ and a floor or base 39′. The second eating utensil 41′ is carried within the opening 33′, and more particularly, carried by the base 39′.

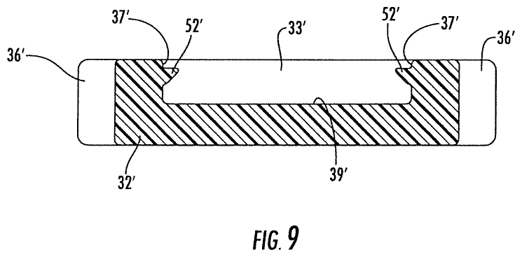

A retaining protrusion 52′ is coupled to the first handle and extending within the opening 33′. The retaining protrusion 52′ may have a sloped or triangular shape (FIG. 9) for retaining the second eating utensil 41′ within the opening 33′. Of course, the retaining protrusion 52′ may have a different or other shape or shapes.

The retaining protrusion 52′ extends within the opening 33′ along a perimeter thereof. The retaining protrusion 52′ does not extend adjacent the cutting blade 44′. In some embodiments, the retaining protrusion 52′ may be continuous around the perimeter of the opening, or there may be multiple retaining protrusions, which may be spaced apart.

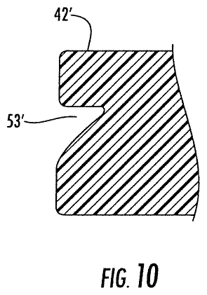

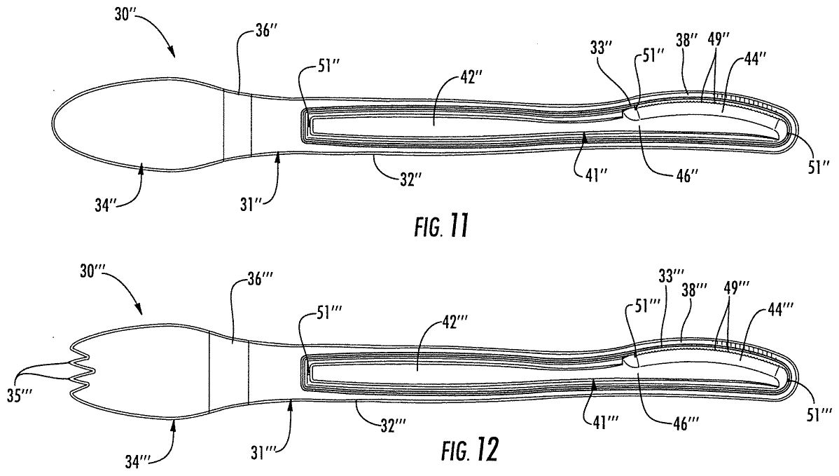

The second handle 42′ has a recess 53′ therein for receiving the retaining protrusion 52′ (FIG. 10). The retaining protrusion 52′ and the recess 53′ cooperate so that the second eating utensil 41′ is retained or coupled within the opening 33′. Conceptually, the second eating utensil 41′ is “snapped” within the recess 53′.

In operation, and where the eating utensil assembly 30′ is plastic, for example, polystyrene, or other pliable material, removal of the second eating utensil 41′ may be accomplished by applying downward pressure to the ends 36′, 46′ of the first eating utensil 31′, or more particularly, the first handle 32′, which causes the second eating utensil to “snap” out of the opening 33′. In other embodiments, for example, where the eating utensil assembly 30′ is metal or other more rigid material, a cut-out or tab may be in the second handle 42′ to allow a user's finger, for example, to pry between the base 39′ and the second handle. Of course, other or additional retaining and removal techniques may be used as will be appreciated by those skilled in the art.

It should be understood that while breakaway tabs 51 and a through-opening 33 have been described with the embodiment illustrated with respect to FIGS. 1-5, and a retaining protrusion 52′ and a blind opening 33′ have been described with respect to the embodiment in FIGS. 6-10, in some embodiments, the breakaway tabs may be used with the blind opening. Similarly, in other embodiments, the retaining protrusion 52′ may be used with the through-opening 33.

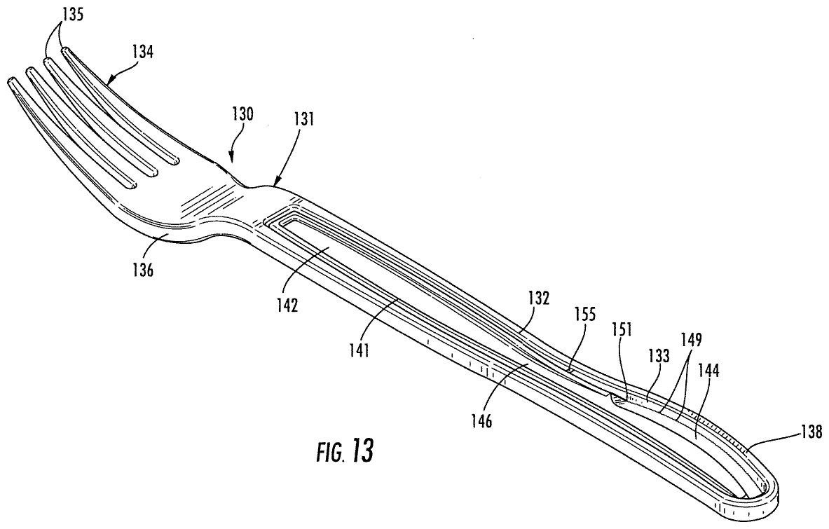

Referring now to FIGS. 11 and 12, in other embodiments, the first eating utensil 31″ may be in the form of a spoon and the curved eating utensil head may be a curved or rounded food container 34″ coupled to the end 36″ of the first handle 32″ (FIG. 11). In yet another embodiment, the first eating utensil 31′″ may be in the form of a spork and the curved eating utensil head may be a curved or rounded food container 34′″ with tines 35′″ extending from the curved food container (FIG. 12). Other elements of the eating utensil assemblies 30″ and 30′″ illustrated are similar to those previously described with respect to FIGS. 1-5.

A method aspect is directed to a method of making an eating utensil assembly 30. The method includes forming a first eating utensil 31 that includes a first handle 32 having an opening 33 therein and an eating utensil head 34 coupled to an end 36 of the first handle and having a curved shape. The method includes forming a second eating utensil 41 to be removably carried by the first eating utensil 31 within the opening 33 in the first handle 32, and including a second handle 42 and a cutting blade 44 coupled to an end 46 of the second handle 42.

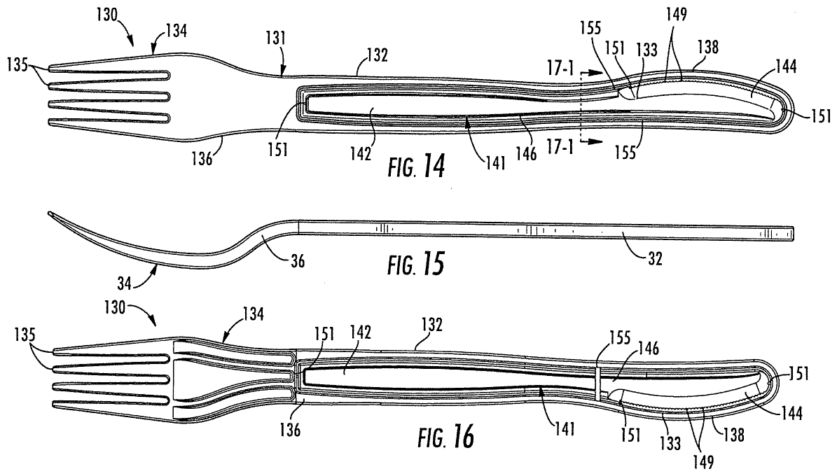

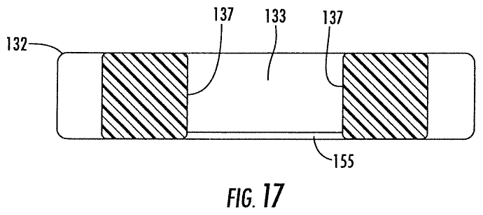

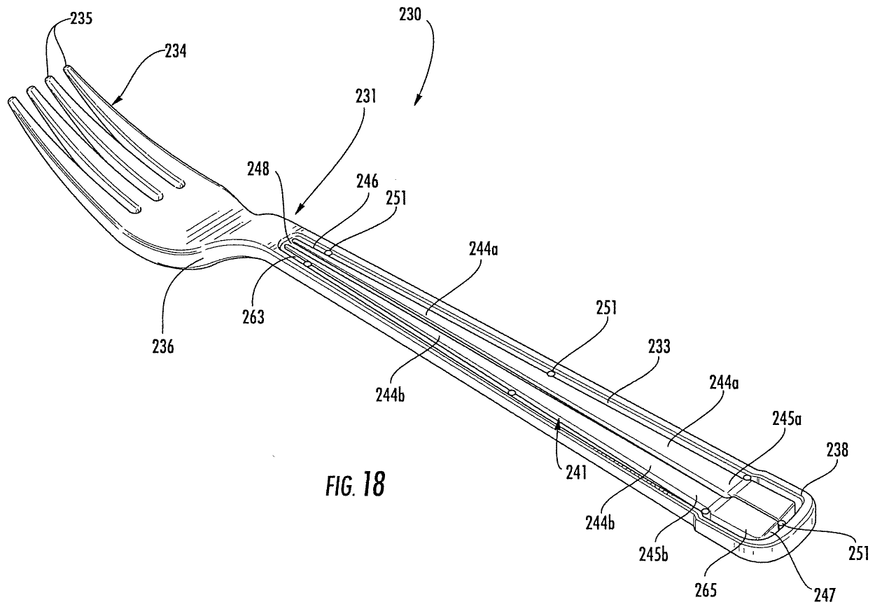

Referring now to FIGS. 13-17, in another embodiment, a support member 155 is coupled across the opening 133 adjacent the bottom of the first eating utensil 131. The support member 155 illustratively has a rectangular shape and is coupled to the first handle 132 between opposing sidewalls 137 of the opening 133. The support member 155 may have another shape.

The second eating utensil 141 is carried within the opening 133 by the support member 155 and coupled within the opening by the coupling bodies or breakaway tabs 151. In some embodiments, the support member 155 may be “tacked” to the handle 142 of the second eating utensil 141 so that it also acts as a coupling body or breakaway tab. Other and/or additional support members 155 may be included, but it may be desirable to maintain the support members relatively small in size and number so as to not overly increase the weight of the eating utensil assembly 130.

Exemplary dimensions of the support member 155 are 8.7 mm long (i.e., across the perimeter of the opening 133) by 1 mm (along a length of the first handle 132 of the first eating utensil 131) wide by 0.75 mm thick. In some embodiments, there may be no breakaway tabs 151 along the perimeter of the opening 133 so that the second eating utensil 141 is removably coupled within the opening by the support member 155.

The support member 155 may be particularly advantageous for increased structural rigidity, particularly during use. For example, without the support member 155, and once the second eating utensil 141 is removed from the opening 133, during use, the sidewalls 137, or the adjacent portions of the first handle 132 of the first eating utensil 131, may bend together from the pressure of holding or using the first eating utensil. The support member 155 provides increased rigidity and reduces bending of the sidewalls 137 toward one another.

Similar to the embodiments described above with respect to FIGS. 1-5, in operation, a user desirous of using the second eating utensil 141, or knife, may “snap” the second eating utensil out from within the opening 133. Either a downward force to the second eating utensil 141 on either side of the support member 155, or an upward force on the second eating utensil 141 relative to the first handle 132 causes the second eating utensil to separate from the breakaway tabs 151. Accordingly, the second eating utensil 141 may be removed upwardly or pushed through the opening 133 on either side of the support member 155 for use. It should be noted that the support member 155 may be used in addition to other features and embodiments, for example, the eating utensil assembly described above with respect to FIGS. 1-5 and FIGS. 11-12.

A method aspect is directed to a method of making an eating utensil assembly 130. The method includes forming a first eating utensil 131 that includes a first handle 132 having an opening 133 therein, a support member 155 coupled to the first handle across the opening, and an eating utensil head 134 coupled to an end of the first handle and having a curved shape. The method also includes forming a second eating utensil 141 to be removably carried by the support member 155 within the opening 133 in the first handle 132. The second eating utensil 141 includes a second handle 142 and a cutting blade 144 coupled to an end of the second handle.

Referring now to FIGS. 18-21, in another embodiment, the eating utensil assembly 230 includes a first eating utensil 231 that includes a first handle 232 having a through-opening 233 therein. The first handle 232 and the through-opening 233 each having a proximal end 236, 263 and an enlarged width distal end 238, 265 that is enlarged relative to the proximal end to define a first handle contour and a through-opening contour, respectively. Illustratively, the first handle contour matches the through-opening contour. A first eating utensil head 234, which is illustratively in the form of a curved eating utensil head, and more particularly, a fork-head, is coupled to the proximal end 236 of the first handle 232. The fork head 234 includes tines 235 that extend outwardly from the proximal end 236 of the first handle 232. In some embodiments, the first eating utensil head 234 may be coupled to the enlarged width distal end 238 of the first handle 232. Similar to the embodiments described above, the first handle 232 is illustratively planar in shape and also has an elongate shape.

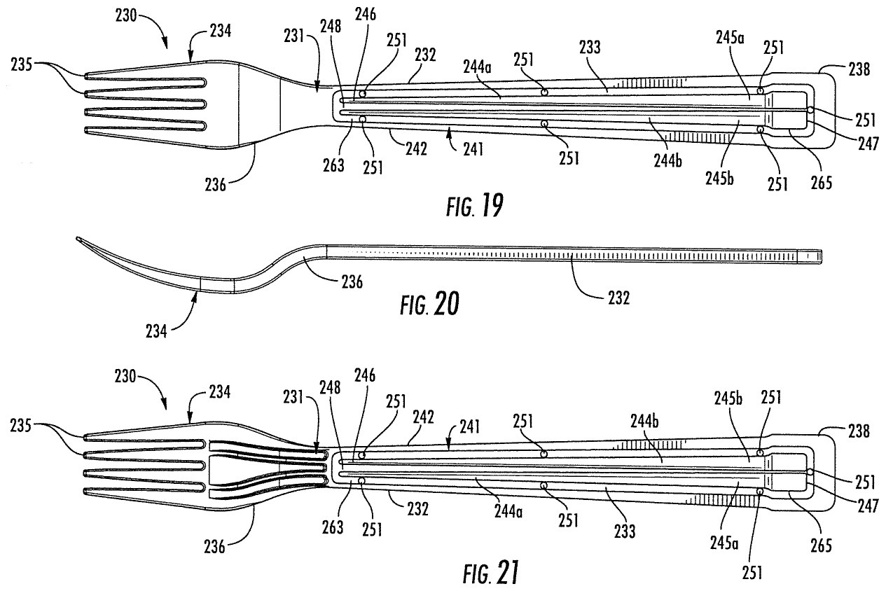

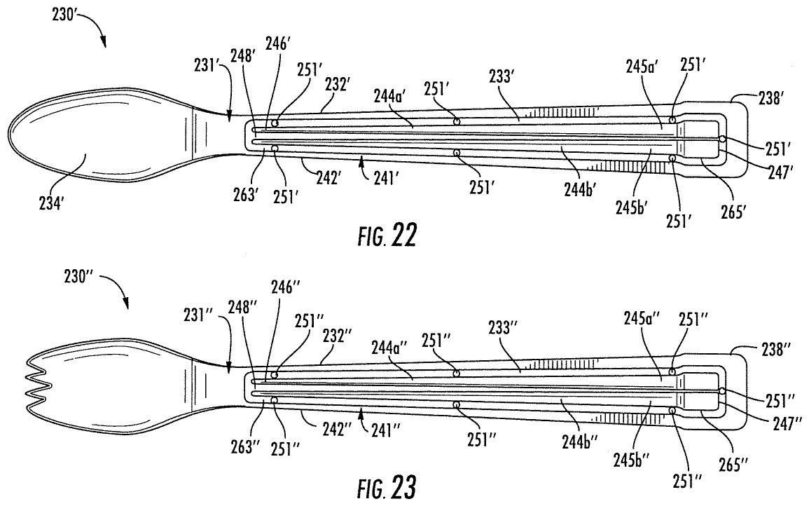

Referring briefly to FIGS. 22-23 in other embodiments, the first eating utensil 231′ may be in the form of a spoon and the curved eating utensil head may be a curved or rounded food container 234′ coupled to the proximal end 236′ of the first handle 232′ (FIG. 22). In yet another embodiment, the first eating utensil 231″ may be in the form of a spork and the curved eating utensil head may be a curved or rounded food container 234″ with tines 235″ extending from the curved food container (FIG. 23). Other elements of the eating utensil assemblies 230′ and 230″ illustrated are similar to those previously described with respect to FIGS. 19-21.

A second eating utensil 241 is removably carried by the first eating utensil 231 within the through-opening 233 in the first handle 232. More particularly, the second eating utensil 241 extends a length of the first handle 232 from the proximal end 263 of the through-opening 233 to the enlarged width distal end 265 of the through-opening. In some embodiments, the second eating utensil 241 may not extend the length of the first handle 232, but instead extend partially along the length of the first handle. The second eating utensil 241 is illustratively flush with an upper surface of the first handle 232. By being flush and not protruding above the first handle 232, a user who may, for example, not desire to use the second eating utensil 241 and leave it carried within the through-opening 233, experience increased comfort when holding the eating utensil assembly 230.

The second eating utensil 241 is illustratively in the form of chopsticks and includes a pair of sticks 244a, 244b, each having a tapered shape. Each of the pair of sticks 244a, 244b has a same length, however, in some embodiments, each of the pair of sticks may have a different size and/or shape. The second eating utensil 241 or pair of sticks 244a, 244b may advantageously be plastic, for example, which generally lends itself well to disposable utensils and is relatively lightweight. Of course, the second eating utensil 241 may be another type of material, for example, wood, metal, etc.

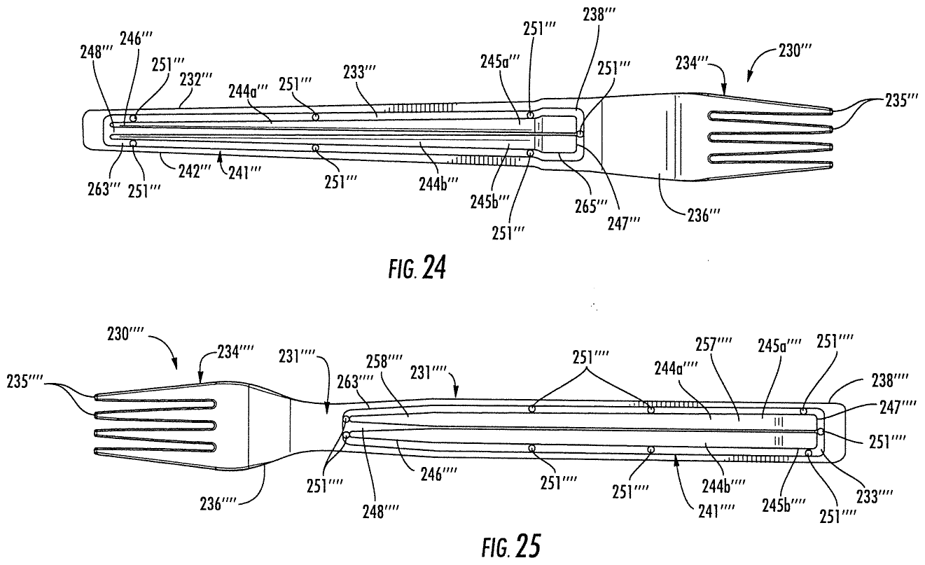

The second eating utensil 241 has a distal end 246 and an enlarged proximal end 247 that is enlarged relative to the distal end 265 of the second eating utensil to define a second eating utensil contour (e.g., having an overall tapered shape). The second eating utensil contour matches the first handle and through-opening contours. The enlarged proximal end 247 of the pair of sticks 244a, 244b is illustratively adjacent the enlarged width distal ends 238, 265 of the first handle 232 and the through-opening 233, respectively. Referring briefly to FIG. 24, an embodiment where the first eating utensil head 232′″ is coupled to the enlarged width distal end 238′″ of the first handle 232′″ is illustrated. The contour or shape of the second eating utensil 241 will be described in further detail below.

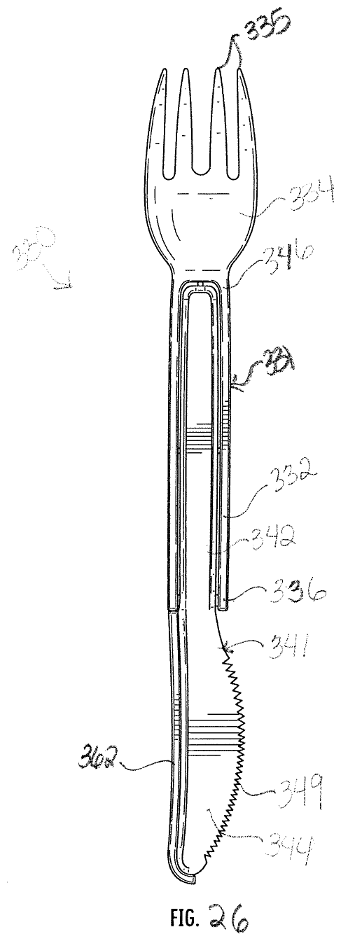

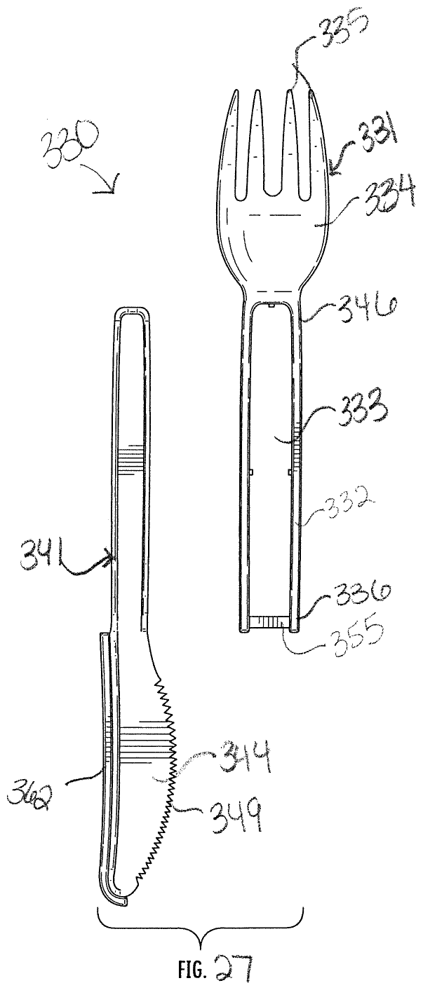

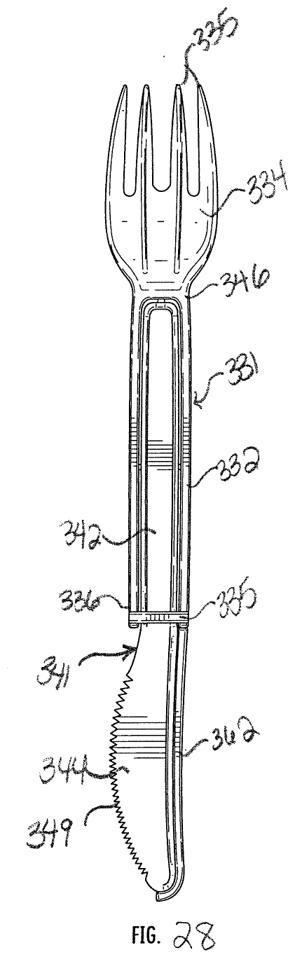

Having a tapered shape, each of the pair of sticks 244a, 244b has an enlarged proximal end 245a, 245b whereby each of the pair of sticks is coupled together. For example, each of the pair of sticks 244a, 244b illustratively has a rectangular shaped enlarged proximal end 245a, 245b to permit relatively easy mating and provide increased coupling area with the other of the pair of sticks. The pair of sticks 244a, 244b are coupled together along a surface of the rectangular shaped enlarged ends 245a, 245b. As a result of the tapered shape of the pair of sticks 244a, 244b along with the coupling arrangement, the pair of sticks are spaced apart from each other adjacent a distal end 246 thereof. In other words, there is a space 248 between each of the pair of sticks 244a, 244b adjacent the distal end 246. The rectangular shaped enlarged proximal ends 245a, 245b of each of the pair of sticks 244a, 244b may be broken away from the rest of their respective stick, for example, by way of a score line, perforation, or other technique to facilitate breakaway. The broken away rectangular shaped enlarged ends 245a, 245b, which despite being broken away from the rest of the stick may still be coupled together, may be used as a rest for the pair of sticks so that the pair of sticks does not contact a table surface, for example. In other embodiments, the pair of sticks 244a, 244b may not be removably coupled to one another, but instead, spaced apart along the length thereof. Moreover, referring briefly and additionally to FIG. 25, it should be understood that the pair of sticks 244a, 244b may be tapered along the entire length thereof, or in some embodiments along a portion thereof, for example, a lower portion 257″″ while the upper portion 258″″ remains straight or not-tapered (FIG. 25).

The pair of sticks 244a, 244b is formed as a monolithic unit. The pair of sticks 244a, 244b may be formed as a monolithic unit along with the rest of the eating utensil assembly 230. In other words, the eating utensil assembly 230 may be integrally molded, for example, of plastic, to define a monolithic unit or eating utensil assembly. The pair of sticks 244a, 244b may have other shapes and may be coupled together by other and/or additional coupling techniques. The pair of sticks 244a, 244b may include wood, metal, plastic, and/or other material or combination of materials.

Breakaway tabs 251 removably couple the second eating utensil 241 to the first eating utensil 231. The breakaway tabs 251 are spaced apart between the second eating utensil 241 and the first eating utensil 231 along a perimeter of the through-opening 233. The breakaway tabs 251 may be equally spaced about along the perimeter in some embodiments. However, in other embodiments, the breakaway tabs 251 may be spaced in another arrangement, for example, to facilitate removal from the through-opening and/or to increase retention strength within the through-opening. The breakaway tabs 251, may be, similarly to the first and second eating utensils 231, 241, plastic and integrally molded therewith to define a monolithic unit. The breakaway tabs 251 may be another material and may not necessarily be the same material as either or both of the first and second eating utensils 231, 241. In some embodiments, there may be a breakaway tab 251 between the spaced apart sticks 244a, 244b adjacent the distal end 248.

Additionally, in some embodiments, the enlarged proximal end 245a, 245b of the pair of sticks 244a, 244b may be adjacent the proximal ends 246, 263 of the through-opening 233 and first handle 231. In such an embodiment, as will be appreciated by those skilled in the art, the breakaway tabs 251, because of the matching contours, may be increased in size adjacent the tapered proximal end of the pair of sticks 244a, 244b.

In operation, a user desirous of using the second eating utensil 241, or chopsticks, may “snap” the second eating utensil out from within the opening 233. A downward or upward force on the second eating utensil 241 relative to the first handle 232 causes the second eating utensil to separate from the breakaway tabs 251. The breakaway tabs 251 may additionally or alternatively separate from sidewalls in the opening 233 allowing the second eating utensil 241 to be used independently of the first eating utensil 231. During use or when use of the second eating utensil 241 is desired, following a pushing down or snapping out of the second eating utensil from the through-opening 233, a user may pull-apart the thinned, tapered, or distal ends 245a, 245b of the pair of sticks 244a, 244b. The pulling apart may cause the coupled together pair of sticks 244a, 244b to snap or break apart, or separate for use as chopsticks.

As will be appreciated by those skilled in the art, in addition to increased convenience, for example, the eating utensil assembly 230 described herein may be particularly advantageous for reducing disposable eating utensil waste. In particular, the amount of material for the eating utensil assembly 230 yields two eating utensils. Additionally, since two or even three utensils are formed in a single utensil body, for example, a user would use a single eating utensil assembly reducing packaging and space, for example, for shipping and counter space at a restaurant. In other words, instead of using a separate utensil or a separate fork, knife, chopsticks, and/or spoon, a single eating utensil assembly 230 described herein may be used, reducing waste by as much as three-times, which also corresponds to reduced cost.

A method aspect is directed to a method of making an eating utensil assembly 230. The method includes forming a first eating utensil 231 that includes a first handle 232 having a through-opening 233 therein. The first handle 232 and the through-opening 233 each have a proximal end 236, 263 and enlarged width distal end 238, 265 that is enlarged relative to the proximal end to define a first handle contour and a through-opening contour, respectively. The first handle contour matches the through-opening contour. The first eating utensil 231 also includes and a first eating utensil head 234 coupled to one of the proximal and distal ends 236, 238 of the first handle. The method also includes forming a second eating utensil 241 removably carried by the first eating utensil 231 within the through-opening 233 in the first handle 232. The second eating utensil 241 has a distal end 246 and an enlarged width proximal end 247 that is enlarged relative to the distal end 265 of the second eating utensil to define a second eating utensil contour. The second eating utensil contour matches the first handle and through-opening contours, and the second eating utensil 241 includes a pair of sticks 244a, 244b each having a tapered shape. The method also includes forming a plurality of breakaway tabs 251 to removably couple the second eating utensil 241 to the first eating utensil 231.

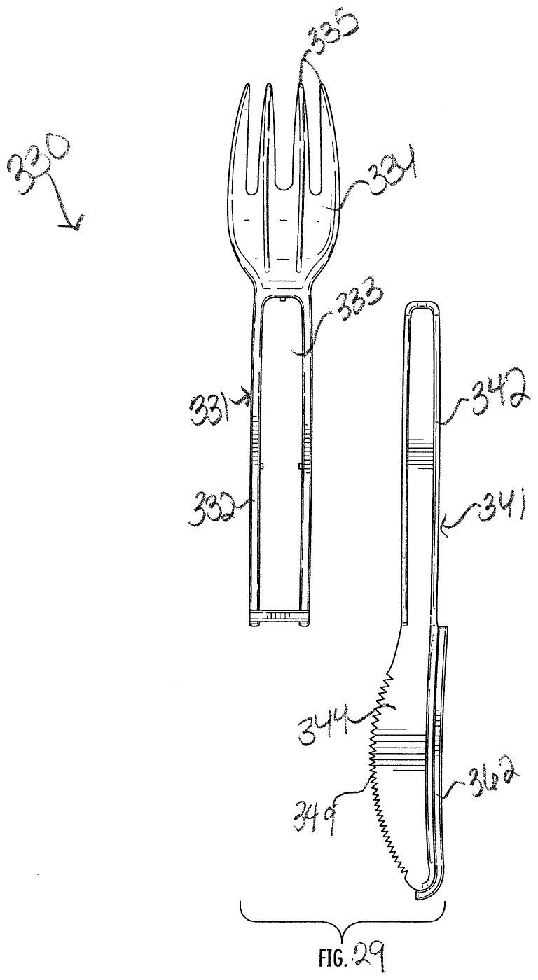

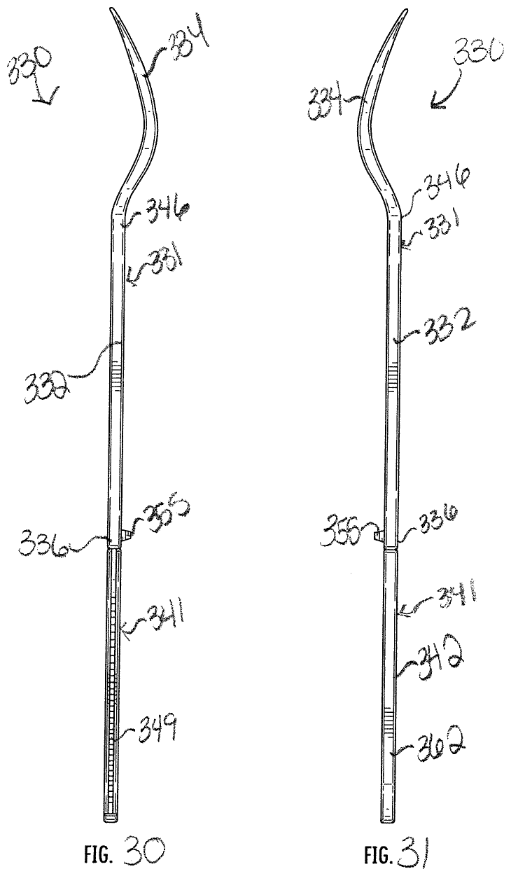

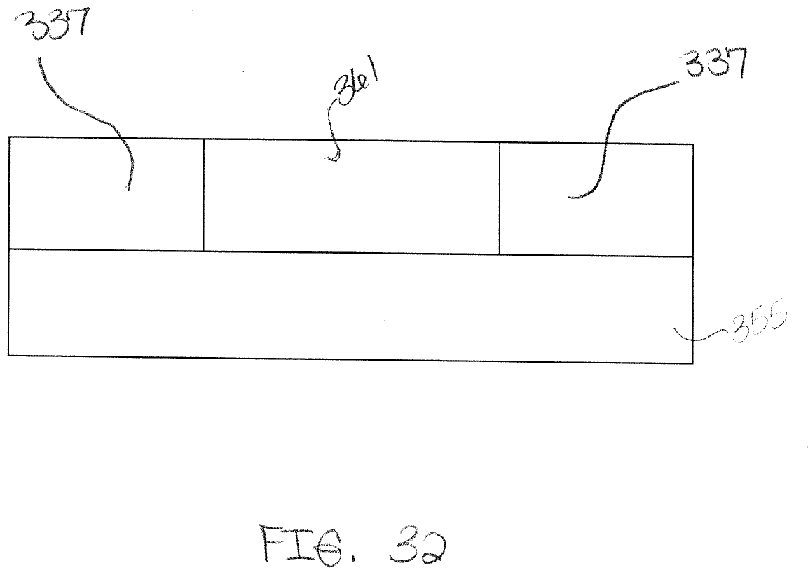

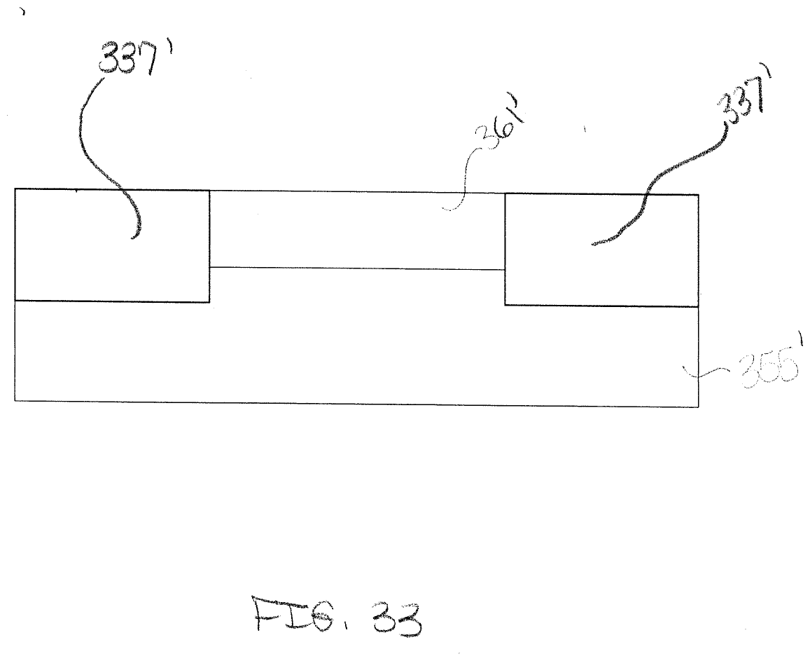

Referring now additionally to FIGS. 26-32 in another embodiment of the eating utensil assembly 330, the first handle 332 may be truncated in length relative to other embodiments. More particularly, the first handle 332 includes first and second opposing ends 336, 346 and spaced apart sidewalls 337 defining a through-opening 333 therebetween. Illustratively, the spaced apart sidewalls 337 are discontinuous at the first end 336.

The first eating utensil handle 332 also includes an end support member 355 coupled between the spaced apart sidewalls 337 adjacent the first end 336, and more particularly, at the first end to define a recessed area 361 relative to the spaced apart sidewalls 337. While the end support member 355 is illustratively coupled across the through-opening 333 at the first end 336, it should be appreciated that the end support member may be positioned adjacent the first end.

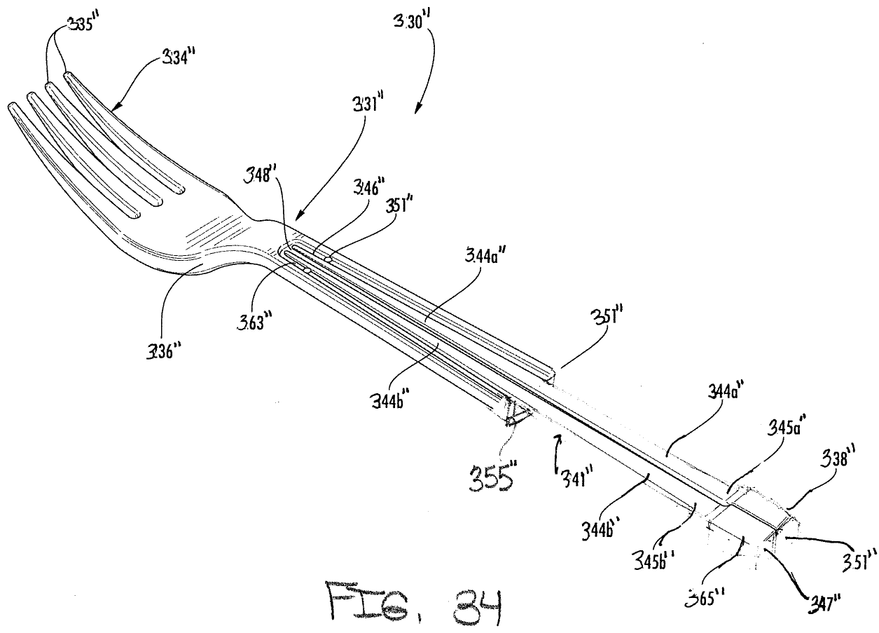

The end support member 355 illustratively has a rectangular shape and does not extend within the through-opening 333 or between the inner facing surfaces of the spaced apart sidewalls 337. In other words, the spaced apart sidewalls 337 have a thickness that matches the thickness of the recessed area 361. In some embodiments, for example, as illustrate in FIG. 33, the end support member 355′ may extend into the through-opening 333′ so that the recessed area 361′ is less than the thickness of the spaced apart sidewalls 361′. Elements illustrated in FIG. 33 that are not specifically described are similar to those described in other embodiments. While the end support member 355 is described as such herein, it should be appreciated by those skilled in the art that the support member may be considered a sidewall.

The first eating utensil 331 also includes a first eating utensil head 334 coupled adjacent, or more particularly, to the second end 346 of the first handle 332. The first eating utensil head 334 illustratively includes spaced apart tines 335 defining a fork.

A second eating utensil 341, illustratively in the form of a knife, is removably carried by the end support member 355 within the through-opening 333. The second eating utensil 341 includes a second handle 342 and a second eating utensil head 344 that is coupled to the second handle. As a knife, the second eating utensil head 344 includes serrations 349.

The second eating utensil has a length greater than a length of the through-opening 333 so that the second eating utensil 341 extends through the recessed area 361 and across the end support member 355 (and past the ends of the spaced apart sidewalls 337). In other words, the second eating utensil 341 defines a cantilever. The second eating utensil 341 and recessed area 361 are relatively sized (e.g., in terms of height or thickness) so that the second eating utensil 341 and first eating utensil 331 are planar.

The through-opening 333 illustratively has a through-opening contour. The second eating utensil 341 has a second handle contour that matches the through-opening contour. In other words, the through-opening 333 and the second handle 342 have a same shape or contour.

The second eating utensil 341 also includes a halo 362 carried by an edge of the second eating utensil head and aligned with one of the spaced apart sidewalls 337. More particularly, the halo 362 may conceptually be considered an extension of one of the spaced apart sidewalls 337 as it has a same size and shape as the adjacent spaced apart sidewall. In some embodiments, the halo 362 may have a different size and/or shape, and/or may be extends a different length.

While the second eating utensil 341 is illustratively in the form of a knife, it should be appreciated by those skilled in the art that the second eating utensil may be another type of utensil, such as, for example, chopsticks 344a″, 344b″ as illustrated in the embodiment in FIG. 34. Elements illustrated in FIG. 34, but not specifically described are similar to those described above.

Breakaway tabs 351, similar to those described above, removably couple the second eating utensil 341 to the spaced apart sidewalls 337 within the through-opening 333, similar to embodiments above. A further breakaway tab may be between the halo 362 and the adjacent one of the spaced apart sidewalls 337. In some embodiments, there may be no breakaway tab or coupling member between the halo 362 and the adjacent one of the spaced apart sidewalls 337. In some embodiments, one or more breakaway tabs may be between the end support member 355 and adjacent portions of the second eating utensil 341. Other elements or techniques may be used to removably couple the end support member 355 to the adjacent portions of the second eating utensil 341.

In another embodiment, the spaced apart sidewalls 337 of the first handle 332 that define the through-opening 333 may include a protrusion or channel. More particularly, the spaced-apart sidewalls 337, which are opposing on opposite sides of the through-opening 333, may extend along a length of the first handle 332.

The through-opening 333 and the second handle 342 of the second eating utensil 341 are, in the present embodiments, relatively sized so that there is no space or gap between adjacent portions thereof along the spaced apart sidewalls 337. However, the second handle 342 of the second eating utensil 341 and the first handle 332 of the first eating utensil 330 are spaced apart at the second end 346. One or more breakaway tabs 351 removably couple the second eating utensil 341 to the first eating utensil 340 within the through-opening 333 at the first end 336. In other words, the contour of the first and second handles 332, 342 match and are relatively sized, or may match, so that when coupled the contours are aligned, and there is a space at the first end 336 for one or more breakaway tabs 351.

The outwardly facing surfaces of the sidewalls of the second handle 342 include the other of the channel or protrusion (i.e., the opposite of the first handle 332) to slideably engage the channel or protrusion of the first handle 332. Accordingly, the channel and protrusion together may define a tongue-and-groove or interlocking arrangement (e.g., having a T-shape, or other shape that permits interlocking). The second eating utensil 341, and more particularly, the second handle 342, extends through the through-opening 333 beyond the first end 336 similar to embodiments described above. However, in the present embodiments, the end support member 355 may not be used and thus no recessed area is defined. Of course, in some embodiments, the end support member 355 may be used in conjunction with the interlocking arrangement described above.

Those skilled in the art will appreciate that the use of the interlocking arrangement may further reduce the amount of material being used, while maintaining structural integrity. During operation, for example, a user may remove or break the coupling of the first and second handles 332, 342 from the breakaway tab or tabs at the second end. This permits the second eating utensil 341 to freely slide outwardly from the second end 346 of the first eating utensil 340 and along the length of the first handle 332 for use. Prior to usage, the first and second eating utensils 340, 341 are coupled by way of the interlocking arrangement and one or more breakaway tabs 351. The embodiments with respect to the interlocking arrangement may be used in conjunction with and one or more element from any of the embodiments described above and with different eating utensil heads 334.

A method aspect is directed to a method of making an eating utensil assembly 330 that may include forming a first eating utensil 341 that includes a first handle 332 having first and second opposing ends 336, 346. The first handle 332 includes spaced apart sidewalls 337 defining a through-opening 333 therebetween, and an end support member 355 coupled between the spaced apart sidewalls adjacent the first end 336 to define a recessed area 361 relative to the spaced apart sidewalls. The first eating utensil 331 also includes a first eating utensil head 334 coupled adjacent the second end 346 of the first handle 332. The method further includes forming a second eating utensil 341 removably carried by the end support member 355 within the through-opening 333. The second eating utensil 341 may have a length greater than a length of the through-opening 333 so that the second eating utensil extends through the recessed area 361 and across the end support member 355. The method may also include forming a plurality of breakaway tabs 351 removably coupling the second eating utensil 341 to the spaced apart sidewalls 337 within the through-opening 333.

While several embodiments have been described herein, it should be appreciated that elements and features of any embodiments may be used along with other elements and features from other embodiments. Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. An eating utensil assembly comprising:
a first eating utensil comprising
a first handle having first and second opposing ends and comprising spaced apart sidewalls defining a through-opening therebetween, and an end support member coupled between the spaced apart sidewalls adjacent the first end to define a recessed area relative to the spaced apart sidewalls, and
a first eating utensil head coupled adjacent the second end of said first handle;
a second eating utensil removably carried by the end support member within the through-opening, the second eating utensil having a length greater than a length of the through-opening so that the second eating utensil extends through the recessed area and across the end support member; and
a plurality of breakaway tabs removably coupling said second eating utensil to said spaced apart sidewalls within the through-opening.

2. The eating utensil assembly of claim 1 wherein said spaced apart sidewalls have a thickness; and wherein the recessed area is sized to be the thickness of said sidewalls.

3. The eating utensil assembly of claim 1 wherein said end support member is coupled between the spaced apart sidewalls at the first end.

4. The eating utensil assembly of claim 1 wherein said second eating utensil comprises:
a second handle; and
a second eating utensil head coupled to said second handle and comprising a plurality of serrations.

5. The eating utensil assembly of claim 4 wherein the through-opening has a through-opening contour; and wherein said second eating utensil handle has a second handle contour matching the through-opening contour.

6. The eating utensil assembly of claim 4 wherein the second eating utensil further comprises a halo carried by an edge of said second eating utensil head and aligned with one of said spaced apart sidewalls.

7. The eating utensil assembly of claim 6 further comprising at least one further breakaway tab between said halo and said one of said spaced apart sidewalls.

8. The eating utensil assembly of claim 1 of wherein said first eating utensil head comprises a plurality of spaced apart tines.

9. The eating utensil assembly of claim 1 wherein said second eating utensil comprises a pair of chopsticks.

10. An eating utensil assembly comprising:
a first eating utensil comprising
a first handle having first and second opposing ends and comprising spaced apart sidewalls defining a through-opening therebetween, and an end support member coupled between the spaced apart sidewalls at the first end to define a recessed area relative to the spaced apart sidewalls, and
a first eating utensil head adjacent the second end of said first handle and comprising a plurality of spaced apart tines;
a second eating utensil removably carried by the end support member within the through-opening, the second eating utensil having a length greater than a length of the through-opening so that the second eating utensil extends through the recessed area and across the end support member; and
a plurality of breakaway tabs removably coupling said second eating utensil to said spaced apart sidewalls within the through-opening.

11. The eating utensil assembly of claim 10 wherein said spaced apart sidewalls have a thickness; and wherein the recessed area is sized to be the thickness of said sidewalls.

12. The eating utensil assembly of claim 10 wherein said second eating utensil comprises:
a second handle; and
a second eating utensil head coupled to said second handle and comprising a plurality of serrations.

13. The eating utensil assembly of claim 12 wherein the through-opening has a through-opening contour; and wherein said second eating utensil handle has a second handle contour matching the through-opening contour.

14. The eating utensil assembly of claim 12 wherein the second eating utensil further comprises a halo carried by an edge of said second eating utensil head and aligned with one of said spaced apart sidewalls.

15. The eating utensil assembly of claim 14 further comprising at least one further breakaway tab between said halo and said one of said spaced apart sidewalls.

16. A method of making an eating utensil assembly comprising:
forming a first eating utensil comprising a first handle having first and second opposing ends and comprising spaced apart sidewalls defining a through-opening therebetween, and an end support member coupled between the spaced apart sidewalls adjacent the first end to define a recessed area relative to the spaced apart sidewalls, and a first eating utensil head coupled adjacent the second end of the first handle;
forming a second eating utensil removably carried by the end support member within the through-opening, the second eating utensil having a length greater than a length of the through-opening so that the second eating utensil extends through the recessed area and across the end support member; and
forming a plurality of breakaway tabs removably coupling the second eating utensil to the spaced apart sidewalls within the through-opening.

17. The method of claim 16 wherein the spaced apart sidewalls are formed to have a thickness matching a thickness of the recessed area.

18. The method of claim 16 wherein the end support member is coupled between the spaced apart sidewalls adjacent at first end.

19. The method of claim 16 wherein forming the second eating utensil comprises:
forming a second handle; and
forming a second eating utensil head coupled to the second handle and comprising a plurality of serrations.

20. The method of claim 19 wherein the through-opening has a through-opening contour; and wherein the second eating utensil handle has a second handle contour matching the through-opening contour.

21. The method of claim 19 wherein the second eating utensil further comprises a halo carried by an edge of the second eating utensil head and aligned with one of the spaced apart sidewalls.

22. The method of claim 21 further comprising forming at least one further breakaway tab between the halo and the one of the spaced apart sidewalls.
